(19) United States
(12) Patent Application Publication
(10) Pub. No.: US 2024/0181624 A1
(43) Pub. Date: Jun. 6, 2024

(54) HAND TOOL SYSTEM

(71) Applicant: Stanley Black & Decker Inc., New Britain, CT (US)

(72) Inventors: Amit L. RAN, Mazkeret Batya (IL); Gregory D. PARKER, Charlotte, NC (US)

(73) Assignee: Stanley Black & Decker Inc., New Britain, CT (US)

(21) Appl. No.: 18/537,430

(22) Filed: Dec. 12, 2023

Related U.S. Application Data
(63) Continuation of application No. PCT/EP2022/064947, filed on Jan. 6, 2022.
(60) Provisional application No. 63/210,178, filed on Jun. 14, 2021.

(51) Int. Cl. B25H 7/00; G01C 9/02

(52) U.S. Cl. CPC B25H 7/00; G01C 9/02

(57) ABSTRACT

A hand tool system includes a first hand tool part and a second hand tool part configured to be releasably connected together with the first hand tool part to form a combination hand tool. The first hand tool part includes a main body and a first connection part, and the second hand tool part includes a main body and a second connection part. The first connection part and the second connection part are configured to be releasably connected together in a state of compression. At least one of the first connection part or the second connection part includes a compression member configured to releasably apply compression to the second connection part or the first connection part to releasably connect the first connection part and the second connection part together.

### CROSS-REFERENCE TO RELATED APPLICATIONS

This application is a continuation of International Application No. PCT/EP2022/064947 filed Jun. 1, 2022, which claims the benefit of U.S. Provisional Application No. 63/210,178 filed on Jun. 14, 2021. The entire disclosure of the above applications is incorporated herein by reference.

### FIELD OF THE INVENTION

The present application relates to hand tools, and particularly relates to a system comprising a plurality of hand tools and/or hand tool parts that selectively may be releasably connected together to form one or more combination hand tools. The application may have utility for levelling and/or measuring and/or layout hand tools, e.g. spirit or bubble vial levels, laser levels, rules, laser distance measurers, and other electronic hand tools, for example.

Embodiments of the application may provide improved hand tools, and an improved hand tool system, in terms of functionality, versatility and ease of use, for example.

### SUMMARY

According to an aspect of an example embodiment, a hand tool system includes: a first hand tool part; and a second hand tool part configured to be releasably connected together with the first hand tool part to form a combination hand tool. The first hand tool part comprises a main body and a first connection part, and the second hand tool part comprises a main body and a second connection part. The first connection part and the second connection part are configured to be releasably connected together in a state of compression. At least one of the first connection part or the second connection part comprises a compression member configured to releasably apply compression to the second connection part or the first connection part to releasably connect the first connection part and the second connection part together.

According to an aspect of an example embodiment, a hand tool system includes: a first hand tool part; and a second hand tool part configured to be releasably connected together with the first hand tool part to form a combination hand tool. The first hand tool part comprises a main body and a first connection part, and the second hand tool part comprises a main body and a second connection part. The first connection part and the second connection part are configured to be releasably connected together. The first hand tool part has a first hand tool functionality and the second hand tool part has a second hand tool functionality.

According to an aspect of an example embodiment, a hand tool system includes: a first hand tool part; and a second hand tool part configured to be releasably connected together with the first hand tool part to form a combination hand tool. The first hand tool part has a first hand tool functionality and the second hand tool part has a second hand tool functionality. The first hand tool part comprises a first electrical connector and the second hand tool part comprises a second electrical connector. The first electrical connector and the second electrical connector are configured to form an electrical connection between the first hand tool part and the second hand tool part when the first hand tool part and the second hand tool part are connected together.

The first hand tool part and/or the second hand tool part may comprise a hand tool that is operational without connection to the other hand tool part. Alternatively, the first hand tool part and/or the second hand tool part may comprise a part that is not operational without connection to the other hand tool part.

In at least some example embodiments or implementations, the hand tool system may further comprise at least a third such hand tool part configured to be releasably connected to the first hand tool part and/or the second hand tool part and/or the combination hand tool, to form another combination hand tool. The hand tool system may comprise multiple (i.e. substantially any plural number of) such hand tool parts, each of which is configured to be releasably connected to any of the other hand tool parts and/or any of one or more such combination hand tools, to form another combination hand tool.

The hand tool system may include a first, second, third or other number of hand tool parts.

In example embodiments of the hand tool system, a first hand tool part has a first hand tool functionality and a second hand tool part has a second hand tool functionality. For example, the first hand tool functionality may be different to the second hand tool functionality. Alternatively, the first hand tool functionality may be the same as the second hand tool functionality. Advantageously, each hand tool part of the system may have a respective functionality, so that combination tools formed by the releasable connection together of two or more hand tool parts may have a plurality of different functionalities, for example. However, the system can also include two or more hand tool parts that have the same, or at least substantially the same, functionality, e.g. two or more substantially identical hand tool parts. Connecting together hand tool parts with substantially the same functionality can be particularly useful for hand tool parts in the form of levels (e.g. spirit or bubble vial levels and/or electronic levels), e.g. so that extended elongate levels may be assembled from a plurality of level parts.

By “hand tool” is meant a tool that may be held and/or manipulated and/or used and/or positioned by hand, preferably with ease and by design. Example embodiments may have particular utility for levelling and/or measuring and/or “layout” hand tools. In example embodiments, a first hand tool part and/or a second hand tool part (and/or any other hand tool part) of the hand tool system of the invention comprises a level, preferably a spirit level and/or bubble level, and/or comprises a distance measurer, preferably a rule. Additionally or alternatively, the first hand tool part and/or the second hand tool part (and/or any other hand tool part) preferably comprises an electronic hand tool and/or an electronic hand tool part and/or electronic hand tool functionality. The electronic hand tool and/or electronic hand tool part and/or electronic hand tool functionality may comprises at least one of: a laser tool; a laser level; a laser line projector; a line laser level; a cross-line laser level; a laser distance measurer, a laser rangefinder; a laser pointer; an inclinometer; an angle finder; a digital level; a LIDAR tool; a laser scanner; a stud sensor; a stud finder; a camera; a flashlight; a work light; a communication device; a Bluetooth communication device; a sound emitter; an audible notification emitter; a display; a display device.

In example embodiments of the hand tool system of the invention, a first hand tool part may comprises a main body and a first connection part and/or a second hand tool part comprises a main body and a second connection part, the connection part of the or each hand tool part preferably attached or attachable to the main body of that hand tool part. Where the hand tool system comprises one or more additional hand tool parts, each additional hand tool part preferably comprises a main body and a respective connection part. Each connection part may have one of two different configurations (e.g. first and second configurations), the two different configurations of connection part configured to be releasably connected together, to releasably connect together separate (e.g. first and second) hand tool parts.

Each connection part may be configured to enable respective hand tool parts to be releasably connected together. For example, a first connection part and a second connection part may be configured to be releasably connected together to releasably connect together first and second hand tool parts.

Respective connection parts may be configured to be releasably connected together in a state of compression and/or tension. For example, first and second connection parts may be configured to be releasably connected together in a state of compression and/or tension.

At least one configuration of connection part include(s) at least one compression member configured to releasably apply compression between its connection part and another connection part to which it is releasably connected, in use. For example, a first connection part and/or a second connection part preferably include(s) at least one compression member configured to releasably apply compression to the first connection part and/or the second connection part to releasably connect the first and second connection parts together. The compression member preferably comprises a screw member and/or a clamp member and/or a clasp member, for example.

For those embodiments or implementations in which the compression member comprises a screw member, the screw member may comprise a screw-threaded member threadably attached or attachable to a first or second connection part and configured to be releasably screwed into compressive contact with a second or first connection part, respectively. In at least some embodiments, at least one of the first and second hand tool parts has an elongate main body with a longitudinal axis, and the screw member (where present) preferably is configured to be screwed in a direction substantially transverse, more preferably substantially perpendicular, to the longitudinal axis. The hand tool part may, for example, comprise an elongate level, e.g. a spirit or bubble vial level.

In some embodiments, a front portion of the screw member may have a surface that is inclined with respect to a direction of movement of the screw member, preferably a substantially conical or frusto-conical surface, configured to apply the compressive contact in a direction that is inclined with respect to the direction of movement of the screw member. The inclined direction of compressive contact preferably is arranged to cause compression and/or tension between the first and second connection parts in two mutually perpendicular directions. The connection part against which the screw member is arranged to be screwed may include an inclined surface against which the screw member is configured to apply the compressive contact.

For those example embodiments in which the compression member comprises a clamp member, the clamp member of the first connection part or the second connection part preferably is configured to be movable with respect to the second connection part or the first connection part respectively, to releasably clamp the first and second connection parts together. For example, the clamp member may be configured to be movable in a second direction to connect together the first and second connection parts in a state of compression and/or tension in a first direction. The second direction may be transverse, including substantially perpendicular, to the first direction. At least one of the first and second hand tool parts has an elongate main body with a longitudinal axis extending substantially in the first direction. The hand tool part may, for example, comprise an elongate level, e.g. a spirit or bubble vial level. The clamp member (where present) may include at least one clamping surface that is inclined with respect to the second direction and/or the first direction. The second connection part or the first connection part, respectively, may include at least one clamp-receiving surface configured to receive the clamping surface of the clamp member in clamping contact therewith, the clamp-receiving surface preferably inclined with respect to the second and/or first direction.

The clamp member (where present) may include a screw fastener and/or a cam lever, e.g. a cam lever mounted on a screw fastener, and/or one or more springs (or other resilient member(s)), configured to enable the movement of the clamp member to releasably clamp the first and second connection parts together.

The first connection part or the second connection part may comprise a protrusion, and the second connection part or the first connection part, respectively, may comprise a recess. The protrusion may be configured to be secured in the recess by the compression member, to releasably connect the first and second connection parts together, thereby to releasably connect together first and second hand tool parts.

In at least some embodiments, each of first and second connection parts (e.g. of some or all hand tool parts of the hand tool system) includes at least one electrical connector, the electrical connectors configured to form an electrical connection between first and second hand tool parts (respectively carrying the first and second connection parts) when the hand tool parts are connected together, in use. For a combination tool comprising more than two connected hand tool parts, the electrical connection may be between some or all of the hand tool parts, for example. The electrical connectors, and the electrical connection formed between connected hand tool parts, enable the electrical interconnection of hand tool parts, to conduct electrical current and/or data between connected hand tool parts of a combination hand tool. For example, one or more batteries carried by one hand tool part may thereby power one or more other connected hand tool parts of a combination hand tool. Additionally, or alternatively, data (e.g. levelling and/or measurement data) from one hand tool part may be transferred to another connected hand tool part for storage and/or display, for example. At least one of the electrical connectors, and in some embodiments each of the electrical connectors, comprises a resilient connector, preferably a spring-loaded connector, especially a so-called pogo pin connector.

As indicated above, one or more hand tool parts of the system may include at least one laser emitter. The, or each, laser emitter preferably comprises a laser diode. The, or each, laser emitter may, for example, comprise an assembly comprising a laser diode and at least one optical component, e.g. a lens, preferably a collimating lens. The, or each, laser emitter assembly may include an enclosure which holds the laser diode and the, or each, optical component, and which includes at least one opening to allow the laser beam to be emitted from the assembly.

In at least some embodiments, the or each laser hand tool part (where present) of the system comprises a laser level. The laser level may be is a spot (point) laser and/or a line laser and/or a rotary laser, configured to emit one or more laser beams to project one or more laser spots and/or laser lines on external surfaces, e.g. walls and/or floors and/or ceilings. For example, the, or each, laser emitter may include a substantially cylindrical lens or a substantially conical reflector, to project one or more laser lines on external surfaces. The laser level may be is configured to emit one or more laser beams in horizontal and/or vertical orientations with respect to gravity, e.g. if the combination hand tool is levelled, in use, by means of one or more bubble vials. Additionally or alternatively, the laser tool, e.g. laser level, may be configured to emit one or more laser beams at any predetermined and/or adjustable orientation with respect to gravity.

For example, the main body of a laser-containing hand tool part may include substantially only the laser emitter(s) and electrical conductors to provide electrical current to the emitter(s), and optionally any other electronic and/or optical device(s), e.g. one or more cameras and/or electronic circuitry (e.g. one or more microprocessors and/or one or more accelerometers). However, in other embodiments, the main body may include a pendulum for alignment of the laser beam(s) with respect to gravity, for example.

One or each laser hand tool part of the system may, for example, comprise a laser hand tool, or tool part, selected from: a spot-laser; a line-laser; a cross-line laser; a combination spot- and line-laser; a 360 degrees line-laser; a rotary laser; an oscillating laser; a red laser; a green laser; a laser distance measurer (LDM); a laser scanner; a LIDAR tool.

### BRIEF DESCRIPTION OF THE DRAWINGS

FIG. 1A is a schematic drawing of an example embodiment of a hand tool system;

FIG. 1B is a schematic drawing of an example embodiment of a hand tool system;

FIG. 1C is a cross-sectional schematic drawing of an example embodiment of a hand tool system;

FIG. 2A is a cross-sectional schematic drawing of an example embodiment of a hand tool system;

FIG. 2B is a cross-sectional schematic drawing of an example embodiment of a hand tool system;

FIG. 2C is a schematic drawing of a connection portion of an example embodiment of a hand tool system;

FIG. 2D is a schematic drawing of a connection portion of an example embodiment of a hand tool system;

FIG. 2E is a cross-sectional schematic drawing of a connection portion of an example embodiment of a hand tool system;

FIG. 3A is a schematic drawing of an example embodiment of a hand tool system;

FIG. 3B is a schematic drawing of an example embodiment of a hand tool system;

FIG. 3C is a schematic drawing of an example embodiment of a hand tool system;

FIG. 3D is a cross-sectional schematic drawing of an example embodiment of a hand tool system;

FIG. 4 is a cross-sectional schematic drawing of an example embodiment of a hand tool system;

FIG. 5 are drawings of an example embodiment of a hand tool system;

FIG. 6 are drawings of an example embodiment of a hand tool system;

FIG. 7 is a drawing of an assembled view of an example embodiment of a hand tool system;

FIG. 8 is a drawing of an exploded view of an example embodiment of a hand tool system;

FIG. 9 is a drawing of an assembled view of an example embodiment of a hand tool system;

FIG. 10 is a drawing of an assembled view of an example embodiment of a hand tool system;

FIG. 11 are drawings of an example embodiment of a hand tool system;

FIG. 12A is a drawing of an exploded view of an example embodiment of a hand tool system;

FIG. 12B is a drawing of an assembled view of an example embodiment of a hand tool system;

FIG. 13 are drawings of an example embodiment of a hand tool system;

FIG. 14 are drawings of an example embodiment of a hand tool system;

FIG. 15 are drawings of an example embodiment of a hand tool system;

FIG. 16 are drawings of an example embodiment of a hand tool system;

FIG. 17 are drawings of an example embodiment of a hand tool system;

FIG. 18 are drawings of an example embodiment of a hand tool system;

FIG. 19 are drawings of an example embodiment of a hand tool system;

FIG. 20 are drawings of an example embodiment of a hand tool system;

FIG. 21 is a cross-sectional view of an end portion of an example embodiment of a hand tool system;

FIG. 22A is an exploded view of a portion of an example embodiment of a hand tool system;

FIG. 22B is an exploded view of a portion of an example embodiment of a hand tool system;

FIG. 23 are drawings of an example embodiment of a hand tool system;

FIG. 24A is partially exploded view of an example embodiment of a hand tool system;

FIG. 24B is partially exploded view of an example embodiment of a hand tool system;

FIG. 24C is an exploded view of an example embodiment of a hand tool system; and

FIG. 24D is a side view of an example embodiment of a hand tool system.

### DETAILED DESCRIPTION OF EXAMPLE EMBODIMENTS

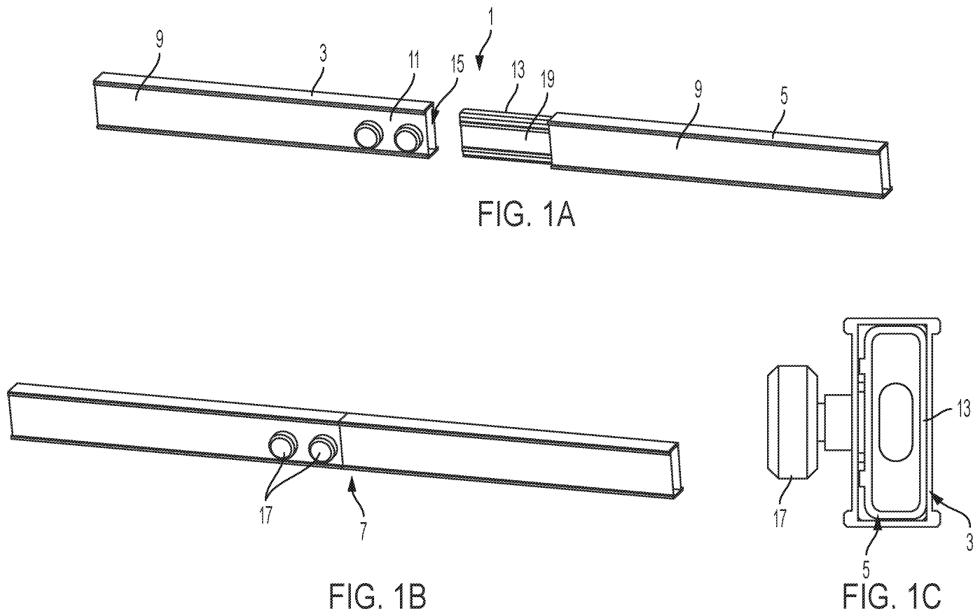

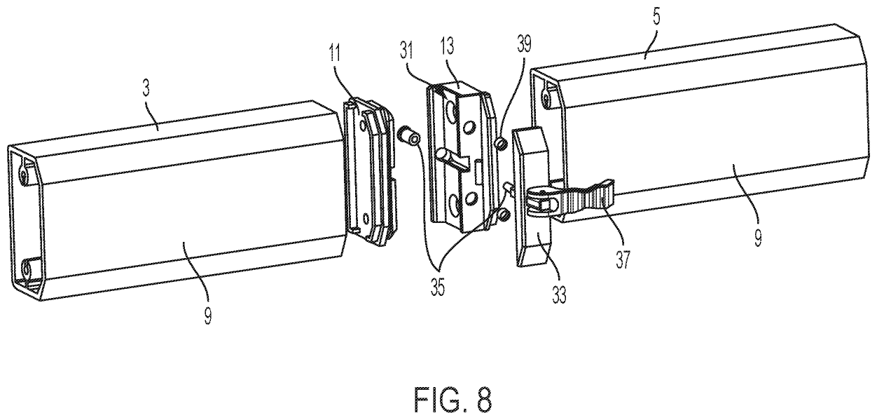

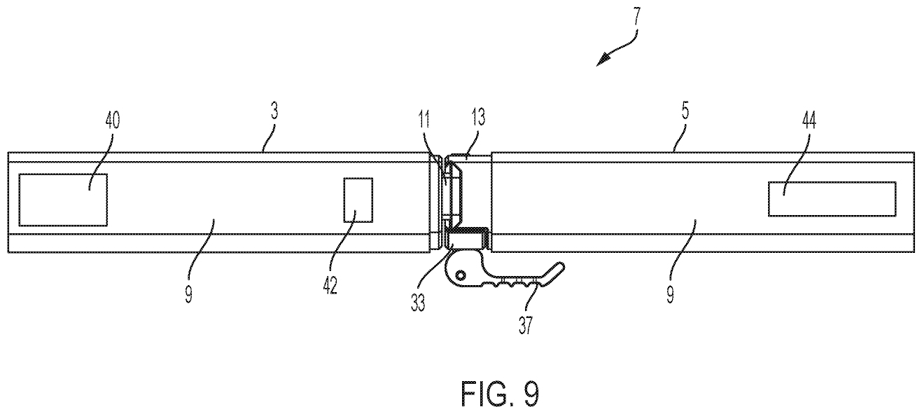

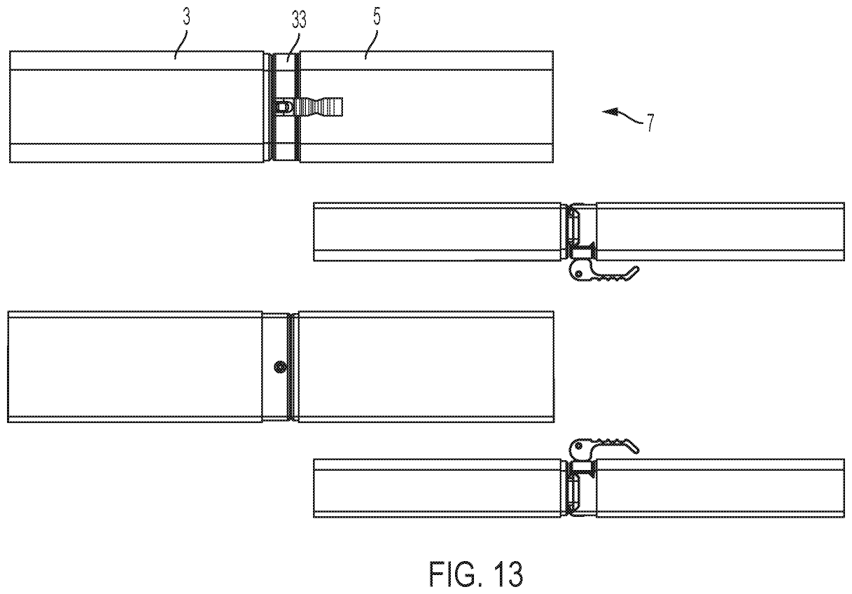

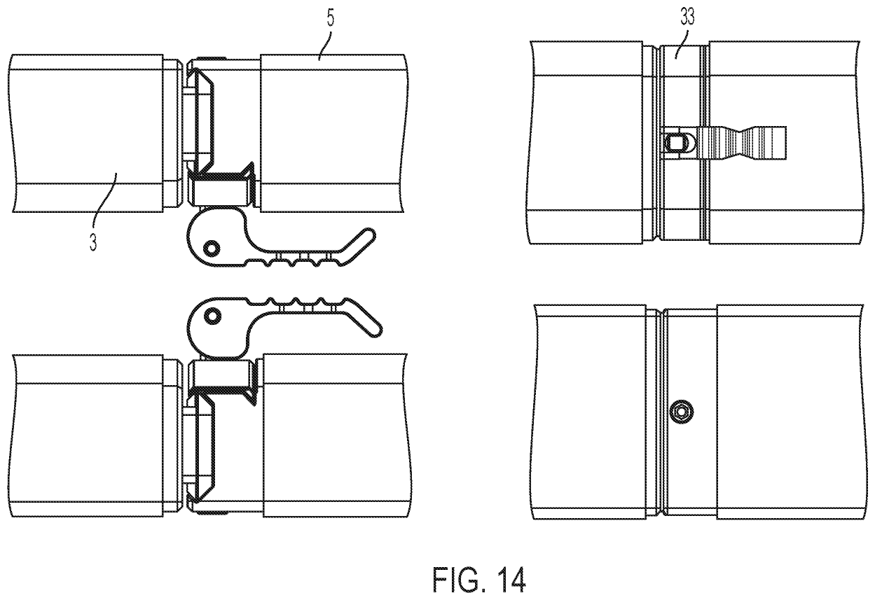

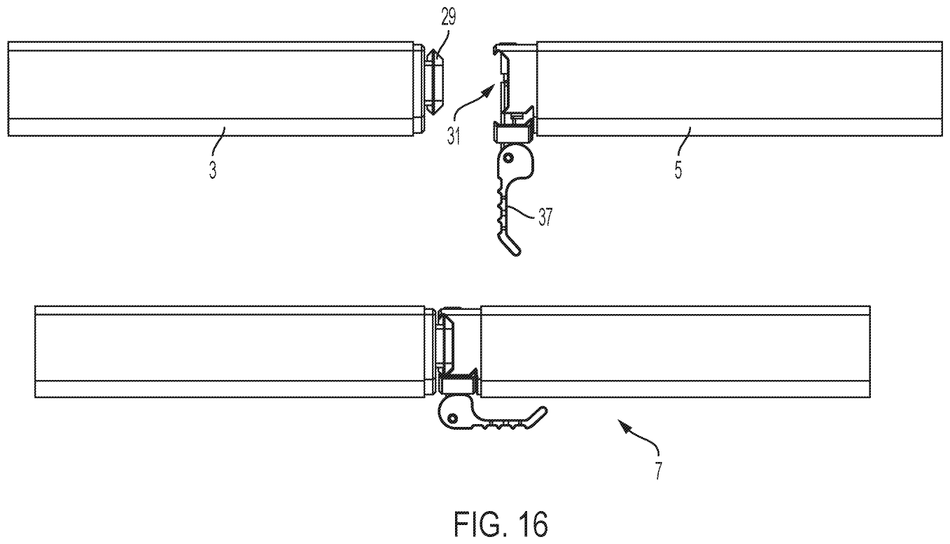

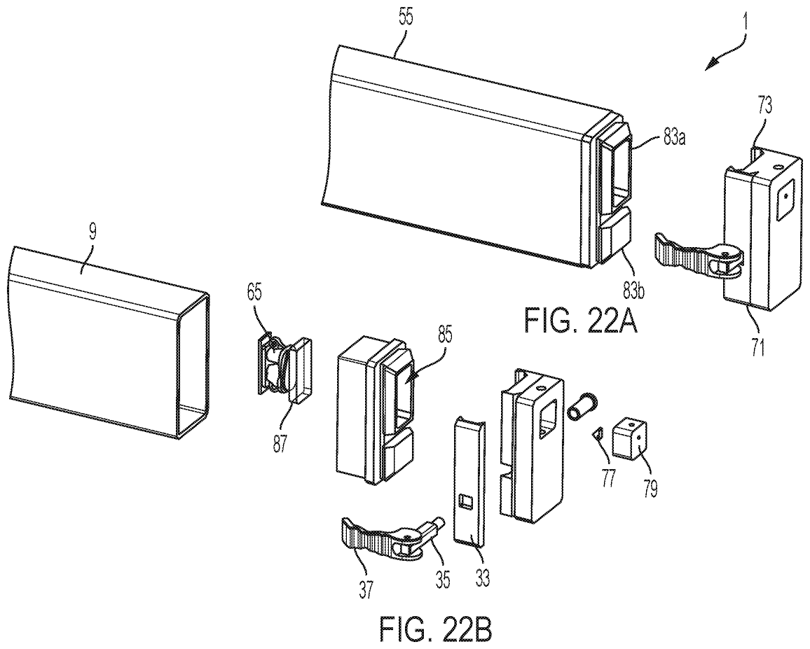

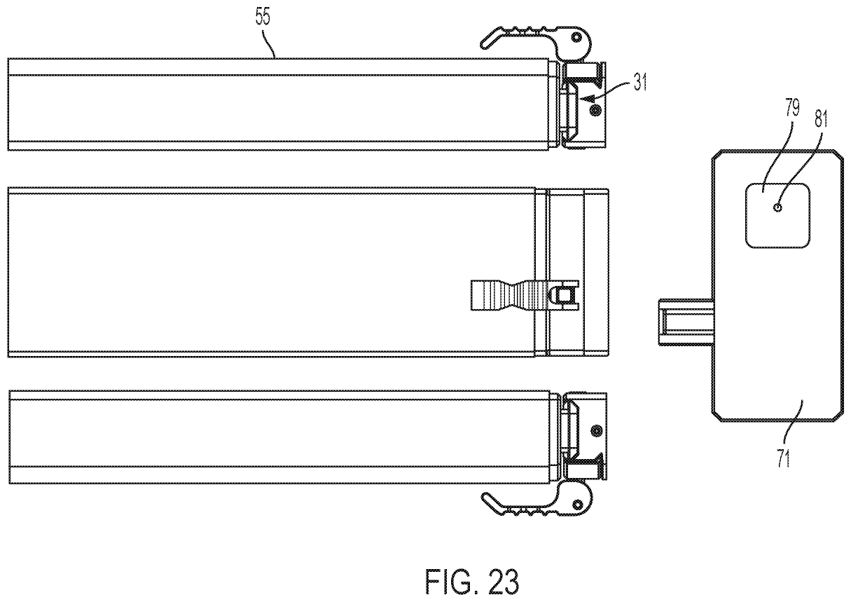

Embodiments and implementations will now be described, by way of example, with reference to the accompanying FIGS. 1 to 24, which show various embodiments, implementations, and views of hand tools and hand tool systems.

In the figures and the following description, the same, or functionally the same or similar, features share the same reference numerals, for simplicity.

FIG. 1 schematically shows a hand tool system 1, comprising a first hand tool part 3 and a second hand tool part 5 configured to be releasably connected together to form a combination hand tool 7. In at least some example embodiments, the hand tool system 1 can further comprise at least a third hand tool part (e.g. multiple hand tool parts) configured to be releasably connected to the first hand tool part 3 and/or the second hand tool part 5 and/or the combination hand tool 7, to form another combination hand tool. In the system 1 shown in FIG. 1, the first hand tool part 3 comprises a spirit level (the bubble vials of which are not shown, for simplicity), and the second hand tool part 5 comprises a spirit level extension part that may be releasably connected to the first hand tool part 3 to extend the length of the spirit level. Additionally or alternatively, the first hand tool part 3 and/or the second hand tool part 5 (and/or any other hand tool part) may comprise an electronic hand tool and/or an electronic hand tool part and/or electronic hand tool functionality. For example, the first hand tool part 3 and/or the second hand tool part 5 may include an electronic display (not shown) and/or one or more accelerometers (not shown), to function (at least in part) as an electronic level, and/or may include further electronic functionality, e.g. one or more laser emitters.

The first hand tool part 3 comprises an elongate main body 9 and a first connection part 11, and the second hand tool part 5 comprises an elongate main body 9 and a second connection part 13. The first connection part 11 comprises a recess in the form of an open end 15 and a pair of compression members in the form of screw members 17, and the second connection part 13 comprises a protrusion 19 configured to be received in the recess 15 and secured therein by means of the screw members 17. Each connection part 11, 13 consequently has one of two different configurations, the two different configurations of connection parts configured to be releasably connected together, to releasably connect together the separate hand tool parts 3, 5 to form the combination hand tool 7.

View (a) of FIG. 1 shows the two hand tool parts 3, 5 separate, view (b) of FIG. 1 shows the two hand tool parts releasably connected together, forming the combination hand tool 7 comprising a level of extended length, and view (c) of FIG. 1 shows a cross-section through the combination hand tool 7. As shown in FIG. 1(c), the screw members 17 are configured to be releasably screwed into compressive contact with the second connection part 13 in a direction transverse, and in particular substantially perpendicular, to the longitudinal axis of the elongate hand tool parts 3, 5. The connection parts 11, 13 are therefore releasably connected together in a state of both compression and tension, as explained below.

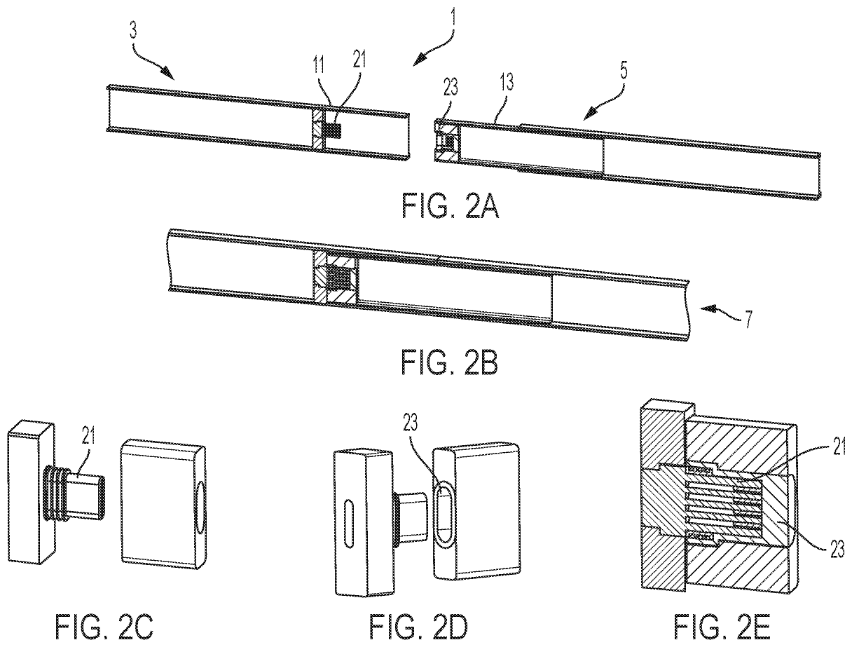

The five views (a) to (e) of FIG. 2 schematically (and in cross-section in views (a), (b) and (e)) show further details of the implementation shown in FIG. 1, in which the respective connection parts 11, 13 include electrical connectors, for forming electrical connections between the two hand tool parts 3, 5. Specifically, connection part 11 includes a male electrical connector 21, and connection part 13 includes a female electrical connector 23.

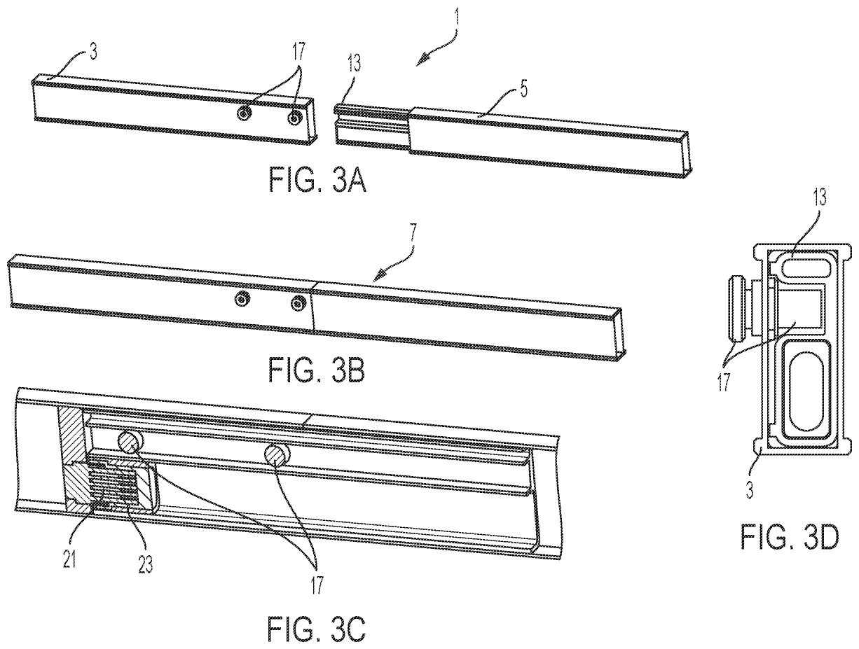

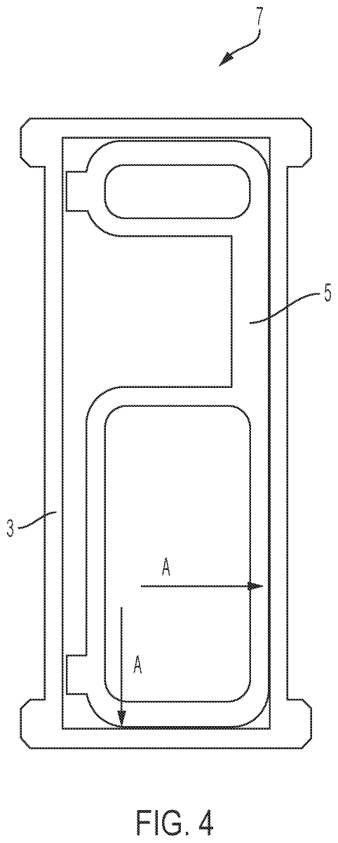

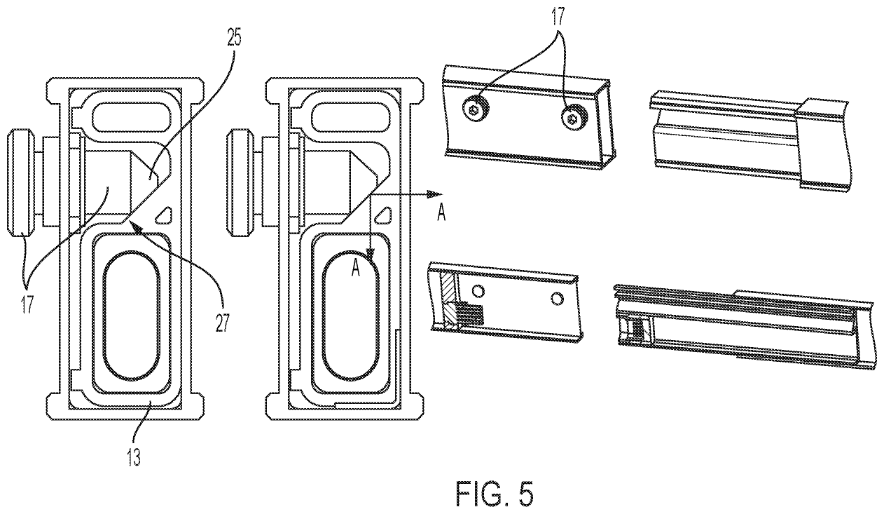

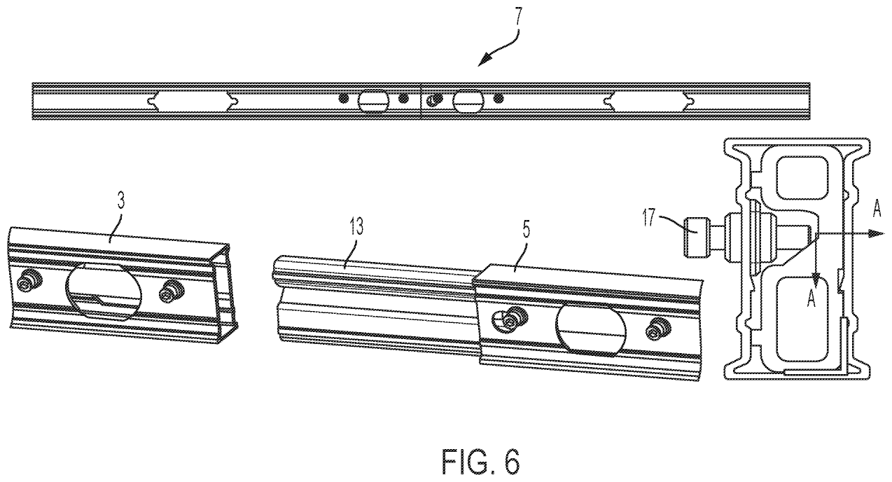

The four views (a) to (d) of FIG. 3 show a variation on the implementation shown in FIGS. 1 and 2. Additionally, the cross-section of the implementation of FIG. 3 shown in FIG. 4 indicates the need, especially for a combination hand tool 7 comprising an extended elongate level, for a “square” connection (i.e. substantially inline and not skewed) between the two hand tool parts 3, 5, preferably with mutually perpendicular compression forces between the two hand tool parts as indicated by the two arrows A. For this purpose, in some example embodiments, for example as shown in FIGS. 5 and 6, a front portion of the, or each, screw member 17 has a surface 25 that is inclined with respect to a direction of movement of the screw member, preferably a substantially conical or frusto-conical surface as illustrated, configured to apply the compressive contact in a direction that is inclined with respect to the direction of movement of the screw member 17. The inclined direction of compressive contact preferably is arranged to cause compression and tension (both compression and tension, due to the equal and opposite reaction forces) between the connection parts 3, 5 in two mutually perpendicular directions. As illustrated in FIGS. 5 and 6, the connection part 13 against which the screw member 17 is arranged to be screwed advantageously includes an inclined surface 27 against which the screw member 17 is configured to apply the compressive contact, with components of the applied compressive force therefore acting in mutually perpendicular directions, perpendicular to the main walls of the connected hand tool parts 3, 5, as indicated by the arrows A.

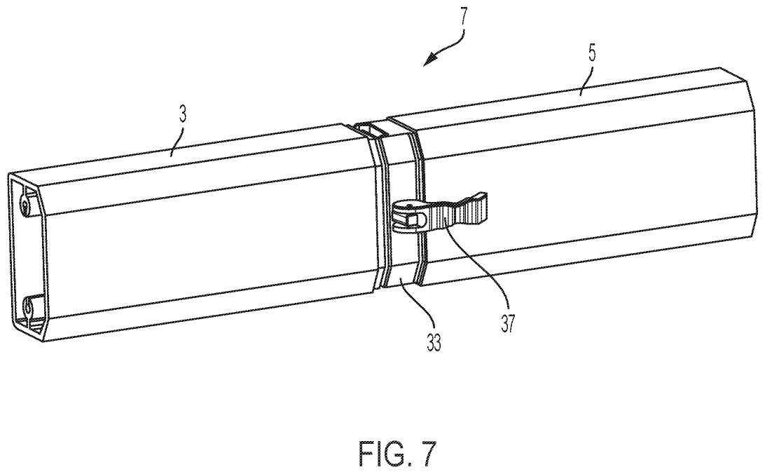

FIGS. 7 to 10 show another embodiment and implementation of the hand tool system 1. In this implementation also, the hand tool system 1 comprises a first hand tool part 3 and a second hand tool part 5 configured to be releasably connected together to form a combination hand tool 7. As already mentioned, in at least some example embodiments, the hand tool system 1 can further comprise at least a third hand tool part (e.g. multiple hand tool parts) configured to be releasably connected to the first hand tool part 3 and/or the second hand tool part 5 and/or the combination hand tool 7, to form another combination hand tool. In the system 1 shown in FIGS. 1 to 10, the first hand tool part 3 comprises a spirit level (the bubble vials of which are not shown, for simplicity), and the second hand tool part 5 comprises a spirit level extension part that may be releasably connected to the first hand tool part 3 to extend the length of the spirit level. Additionally or alternatively, the first hand tool part 3 and/or the second hand tool part 5 (and/or any other hand tool part) may comprise an electronic hand tool and/or an electronic hand tool part and/or electronic hand tool functionality. For example, the first hand tool part 3 and/or the second hand tool part 5 may include an electronic display 40 and/or one or more accelerometers 42, to function (at least in part) as an electronic level, and/or may include further electronic functionality, e.g. one or more laser emitters. Additionally, the first hand tool part 3 and/or the second hand tool part 5 may include one or more batteries 44 for powering the electronics.

In the embodiment of FIGS. 7 to 10, the first hand tool part 3 comprises an elongate main body 9 and a first connection part 11, and the second hand tool part 5 comprises an elongate main body 9 and a second connection part 13. As illustrated, both of the first and second hand tool parts 3 and 5 have an elongate main body 9 with a longitudinal axis extending substantially in a first direction. Each connection part 11, 13 has one of two different configurations, the two different configurations of connection parts configured to be releasably connected together, to releasably connect together the separate hand tool parts 3, 5 to form the combination hand tool 7. The first connection part 11 comprises a protrusion 29, and the second connection part 13 comprises a recess 31, and each connection part may take the form of an end cap secured to the end of (for example) an extruded metal elongate main body 9, as illustrated.

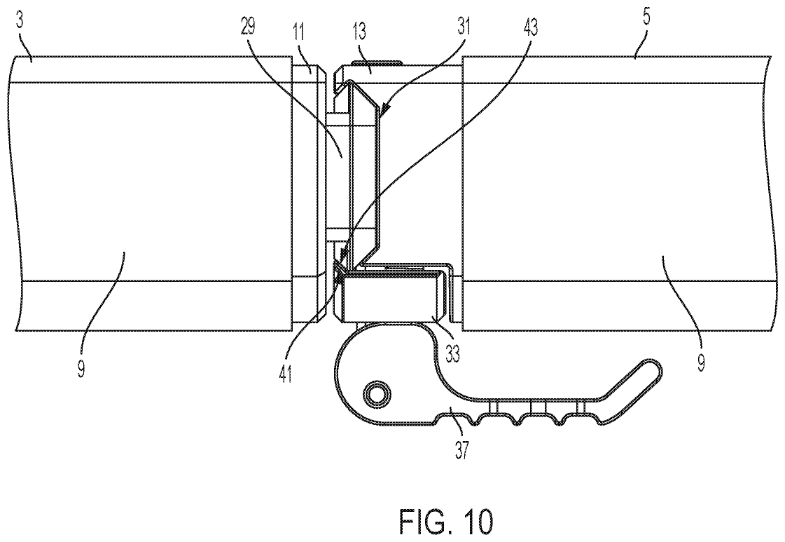

The protrusion 29 is configured to be secured in the recess 31 by a movable compression member 33 of the second connection part 13, which compression member 33, as most clearly shown in FIG. 10, functionally has the form of a jaw of a clamp. The compression member (or clamp member) 33 is movably attached or attachable to the remainder of the second connection part 13 by means of a screw fastener 35, and a cam lever 37 mounted on the screw fastener 35. The clamp/compression member 33 is configured to be movable in a second direction to connect together the first and second connection parts 3 and 5 in the first direction. The second direction is transverse, and substantially perpendicular, to the first direction. Additionally, a pair of resilient members 39 in the form of springs are configured to bias the clamp/compression member 33 laterally (in a transverse direction) away from the remainder of the second connection part 13 until rotation of the cam lever 37 to the orientation shown in the figures overcomes the spring bias and causes the clamp/compression member 33 to be forced against the remainder of the second connection part 13. If this is done after the protrusion 29 of the first connection part 11 has been correctly inserted into the recess 31 of the second connection part 13, then, as shown in FIG. 10, the protrusion 29 is firmly clamped in the recess 31, and the first and second connection parts 11 and 13 are releasably connected together, thereby releasably connecting together the first and second hand tool parts 3 and 5.

As most clearly shown in FIG. 10, the clamp/compression member 33 includes a clamping surface 41 that is inclined with respect to both the second direction and the first direction and facing generally towards the recess 31 of the second connection part 13. The protrusion 29 of the first connection part 11 includes a clamp-receiving surface 43 configured to receive the clamping surface 41 of the clamp/compression member 33 in clamping contact therewith, the clamp-receiving surface 43 correspondingly inclined with respect to both the second and the first direction and facing generally away from the recess 31 of the second connection part 13. Consequently, when the clamp/compression member 33 is forced transversely against the remainder of the second connection part, with the protrusion 29 of the first connection part 11 correctly inserted into the recess 31 of the second connection part, the protrusion 29 of the first connection part 11 is drawn or pulled into a compressive contact/engagement with the recess 31 of the second connection part 13, thereby securely (but releasably) connecting together the first and second hand tool parts 3 and 5. The clamp/compression member 33 and the remainder of the second connection part 13 are consequently in tension (due to the reaction forces).

To subsequently release, i.e. disconnect, the first and second hand tool parts 3 and 5 from each other, the cam lever 37 is rotated by the user (in a clockwise direction as viewed in FIG. 10), thereby enabling the resilient members 39 to force the clamp/compression member 33 away from the remainder of the second connection part 13, thereby releasing the protrusion 29 (or enabling the removal of the protrusion 29) from the recess 31.

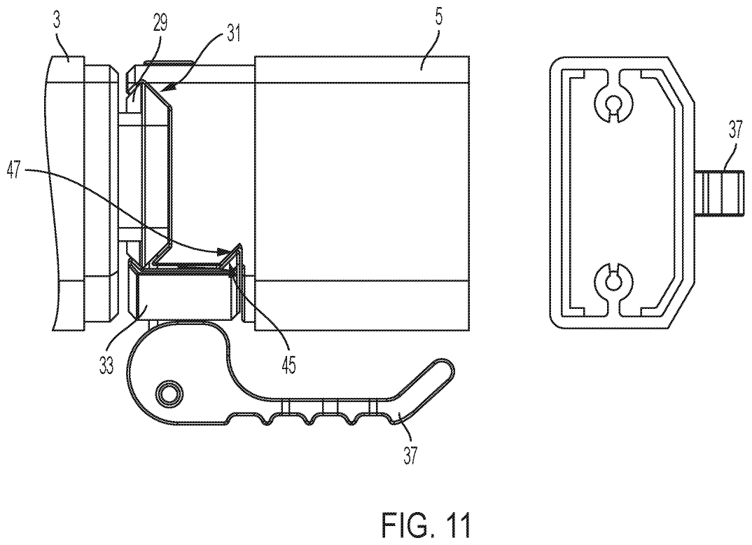

FIGS. 11 to 16 show a variation on the embodiment/implementation of FIGS. 7 to 10, in which the clamp/compression member 33 includes a second clamping surface 45 that is inclined with respect to both the second direction and the first direction, and spaced from and facing generally towards the first clamping surface 41. Additionally, the remainder of the second connection part 13 includes a correspondingly inclined clamp-receiving surface 47 for receiving the second clamping surface 45. These additional clamping and clamp-receiving surfaces can provide additional stability to the connection, for example.

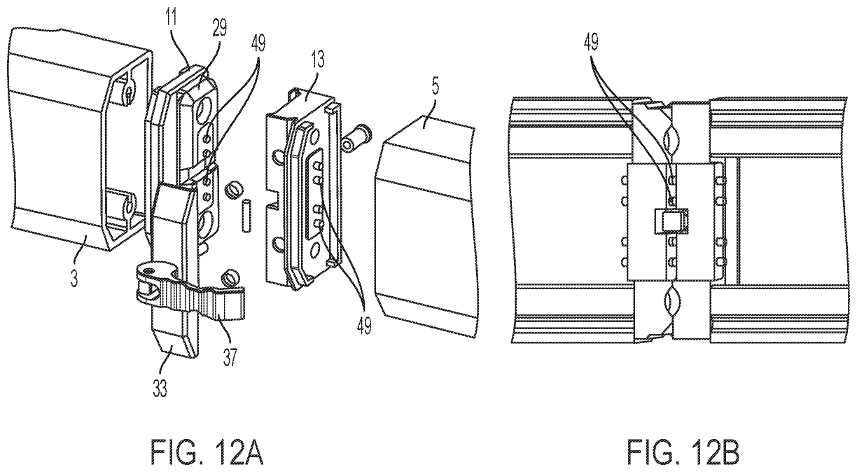

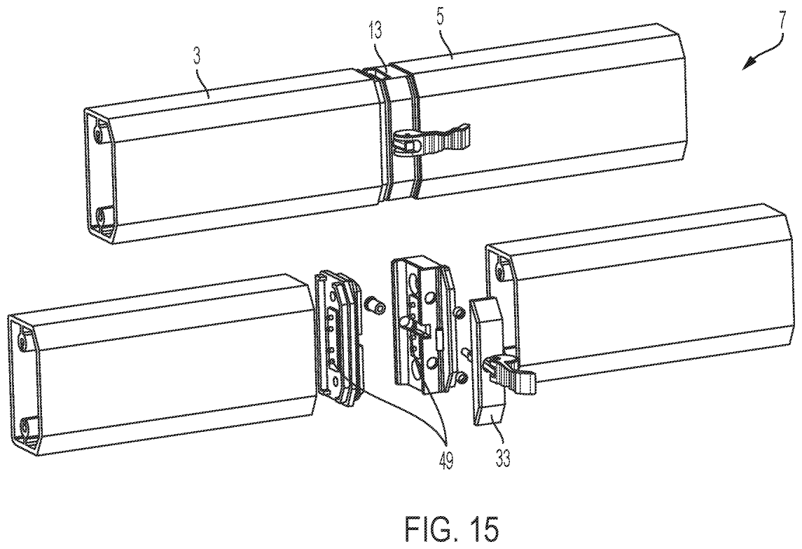

FIGS. 12 and 15 show further details of this embodiment/implementation, in which the respective connection parts 11, 13 include electrical connectors 49, for forming electrical connections between the two hand tool parts 3, 5. The electrical connectors 49 comprise resilient, spring-loaded, connectors, specifically so-called pogo pin connectors. The electrical connectors 49 are configured to conduct electrical current and/or data between the hand tool parts of the combination hand tool, for electronic hand tool functionality (not shown in FIG. 12) of one or both hand tool parts. Other features of the embodiment/implementation of FIGS. 11 to 16 are substantially the same as those of FIGS. 7 to 10.

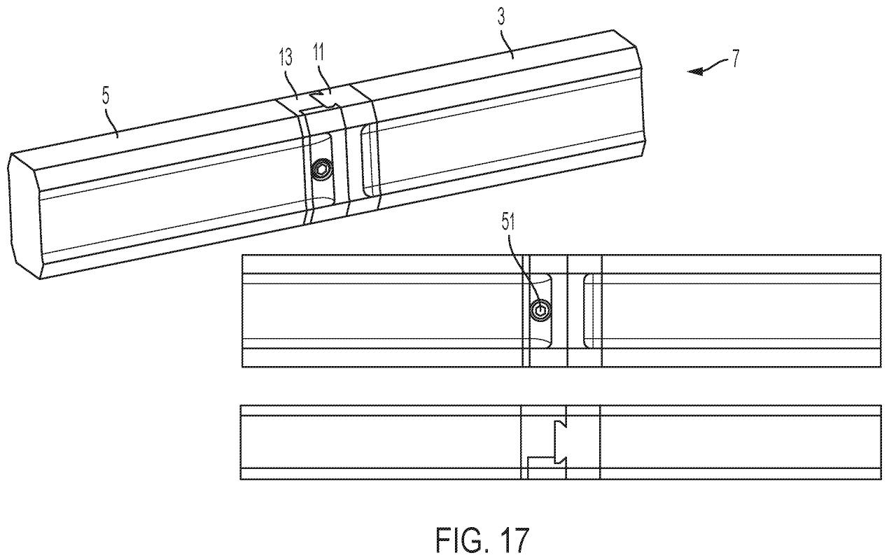

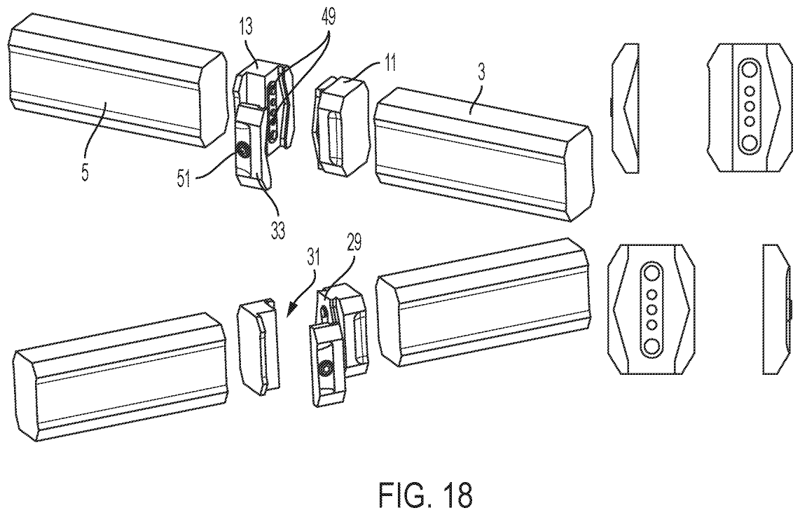

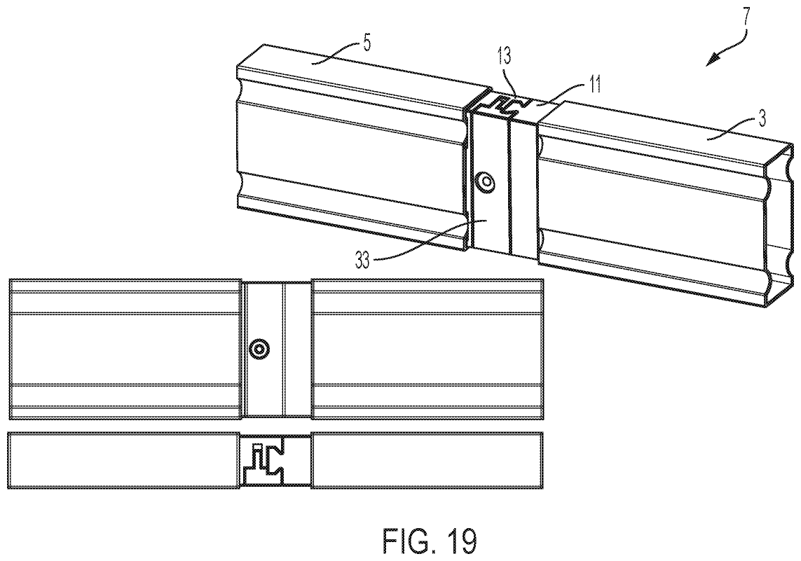

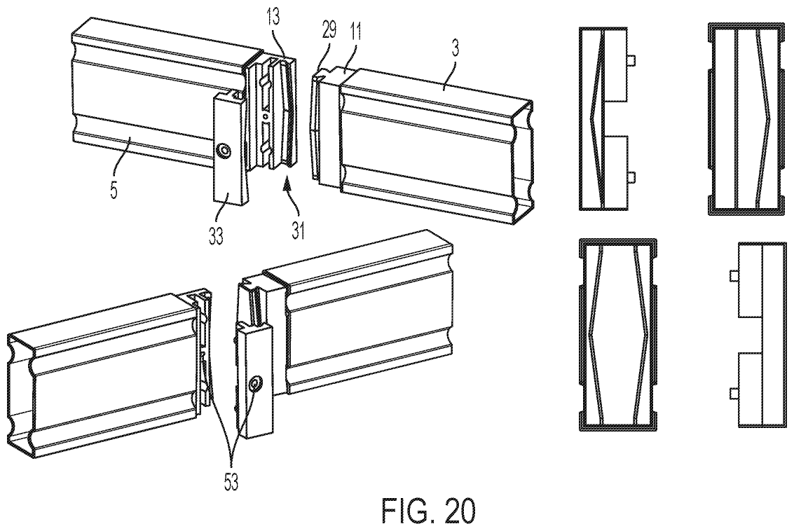

FIGS. 17 to 20 show two additional embodiments; FIGS. 17 and 18 show one embodiment, and FIGS. 19 and 20 show another embodiment. In each of these embodiments/implementations, the clamp/compression member 33 is movably connected to the remainder of its connection part 13 by means of a screw fastener 51 (not shown in FIGS. 19 and 20, but holes 53 for the screw fastener 51 are shown).

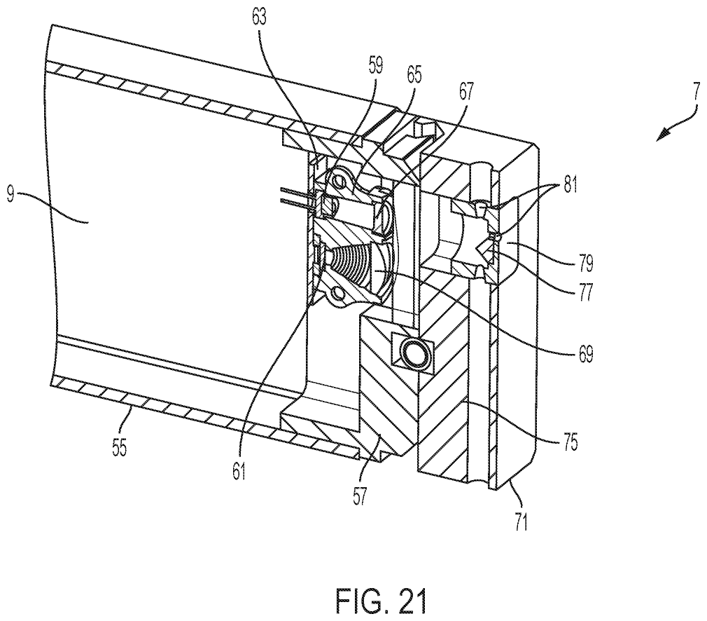

FIGS. 21 to 23 show a further embodiment/implementation. In this embodiment/implementation, the hand tool system 1 comprises at least one first hand tool part 55 having an elongate main body 9 (e.g. forming a level, and preferably formed from extruded metal) and a first connection part 57 in the form of a modified end cap fitted into an open end of the elongate main body 9. The end cap/first connection part 57 includes laser distance measurer (LDM) functionality comprising a laser emitter 59 (in the form of a laser diode), a laser light receiver 61, and a circuit board 63 to which the laser emitter 59 and laser light receiver 61 are mounted or otherwise connected. The circuit board 63 may carry and/or be electrically connected to, electronics of the LDM, for example. The laser emitter 59 and laser light receiver 61 are mounted in an LDM module 65, to which respective lenses 67 and 69 are also mounted. The first hand tool part 55 may also carry one or more batteries (not shown) for powering the LDM electronics. The first hand tool part 55 therefore functions as a laser distance measurer, and may also function as a level, e.g. a spirit (or bubble vial) level and/or an electronic level and/or an inclinometer.

The hand tool system 1 shown in FIGS. 21 to 23 also includes a second hand tool part 71 having a second connection part 73 configured to be releasably connected to the first connection part 57. The second hand tool part 71 also includes a main body 75, the main body 75 including a beam splitter 77 and a mount 79 for the beam splitter 77. The beam splitter 77 is configured to convert the laser beam emitted, in use, by the laser emitter 59 of the first hand tool part 55, into a plurality of laser beams (not shown) to be emitted from the combination hand tool 7 formed when the first and second hand tool parts 55 and 71 are releasably connected together. The beam splitter mount 79 includes a plurality (three, in the illustrated embodiment) of windows 81 for the passage of mutually perpendicular laser beams to be emitted from the combination hand tool 7, in use. The mutually perpendicular laser beams may function as levelling and/or plumb beams for levelling and/or “layout” purposes, and the laser beams my be levelled/aligned with respect to gravity by means of the levelling functionality (not shown) of the first hand tool part 55 of the combination hand tool 7. The connection of the second hand tool part 71 to the first hand tool part 55 therefore converts the first hand tool part from a level and LDM, into a laser level.

The first connection part 57 comprises a plurality of protrusions 83a and 83b, one of which, 83a, has an opening 85 for the LDM module 65 and a transparent cover 87 for protecting the LDM module 65 in the first hand tool part while allowing the passage of laser light therethrough. The second connection part 73 comprises a recess 31 for the protrusions 83a and 83b, a clamp/compression member 33, a cam lever 37, and a screw fastener 35 to which the cam lever 37 is mounted. The first and second connection parts 57 and 73 may therefore be releasably connected together substantially as described above with reference to FIGS. 7 to 16.

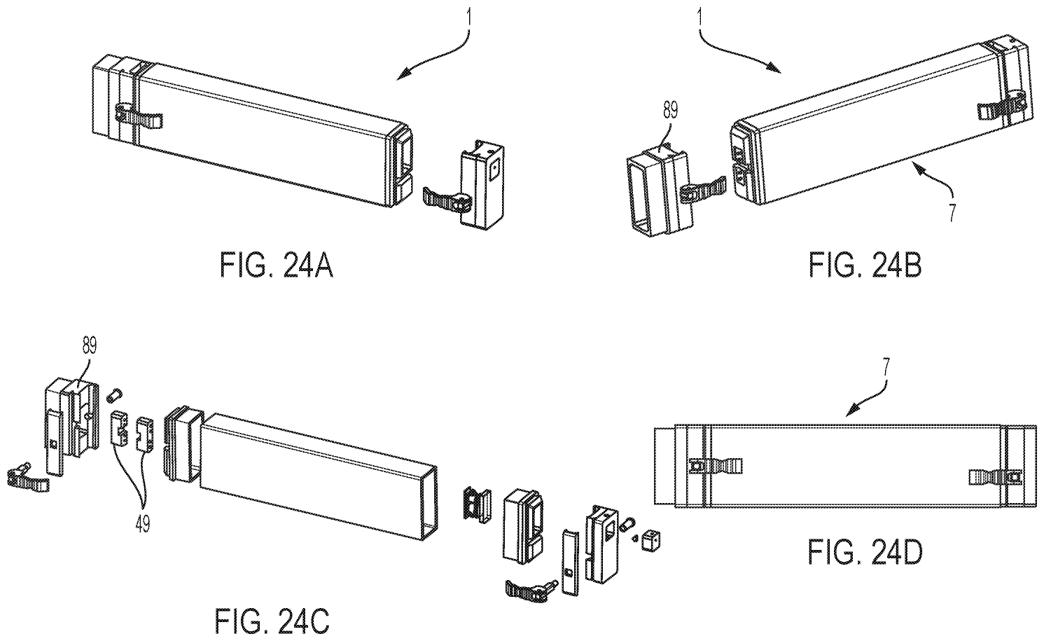

Views (a) to (d) of FIG. 24 show the hand tool system 1 and combination hand tool 7 of FIGS. 21 to 23, together with a third hand tool part 89 for electrical and/or electronic accessories and/or functionalities. The releasable connection between the first hand tool part 55 and the third hand tool part 89 includes electrical connectors 49.

It is to be understood that the described and illustrated embodiments and implementations of the invention are examples, and that other embodiments and implementations fall within the scope of the claimed invention. It is to be understood that the present disclosure contemplates that, to the extent possible, one or more features of any embodiment can be combined or exchanged with one or more features of any other embodiment.

What is claimed is:

1. A hand tool system, comprising:
a first hand tool part;
a second hand tool part configured to be releasably connected together with the first hand tool part to form a combination hand tool;
wherein the first hand tool part comprises a main body and a first connection part, and the second hand tool part comprises a main body and a second connection part,
wherein the first connection part and the second connection part are configured to be releasably connected together in a state of compression; and
wherein at least one of the first connection part or the second connection part comprises a compression member configured to releasably apply compression to the second connection part or the first connection part to releasably connect the first connection part and the second connection part together.

2. The hand tool system according to claim 1, wherein the compression member comprises at least one of a screw member or a clamp member.

3. The hand tool system according to claim 1, wherein at least one of the first hand tool part or the second hand tool part comprises a hand tool that is operational without connection to the other hand tool part.

4. The hand tool system according to claim 1, wherein at least one of the first hand tool part or the second hand tool part comprises a part that is not operational without connection to the other hand tool part.

5. The hand tool system according to claim 1, wherein the first hand tool part has a first hand tool functionality and the second hand tool part has a second hand tool functionality.

6. The hand tool system according to claim 5, wherein the first hand tool functionality is different to the second hand tool functionality.

7. The hand tool system according to claim 5, wherein the first hand tool functionality is the same as the second hand tool functionality.

8. The hand tool system according to claim 1, wherein the first hand tool part comprises at least one of a level or a distance measurer.

9. The hand tool system according to claim 1, wherein the first hand tool part comprises an electronic hand tool.

10. The hand tool system according to claim 1, wherein the first connection part and the second connection part are configured to be releasably connected together in a state of tension.

11. The hand tool system according to claim 1, wherein the first connection part comprises a first electrical connector and the second connection part comprises a second electrical connector;
wherein the first electrical connector and the second electrical connector are configured to form an electrical connection between the first hand tool part and the second hand tool part when the first hand tool part and the second hand tool part are connected together.

12. A hand tool system according to claim 11, wherein at least one of the first electrical connector and the second electrical connector comprises a resilient connector.

13. A hand tool system according to claim 1, further comprising a third hand tool part configured to be releasably connected to at least one of the first hand tool part or the second hand tool part to form another combination hand tool.

14. A hand tool system, comprising:
a first hand tool part;
a second hand tool part configured to be releasably connected together with the first hand tool part to form a combination hand tool;
wherein the first hand tool part comprises a main body and a first connection part, and the second hand tool part comprises a main body and a second connection part,
wherein the first connection part and the second connection part are configured to be releasably connected together;
wherein the first hand tool part has a first hand tool functionality and the second hand tool part has a second hand tool functionality.

15. The hand tool system of claim 14, wherein the first hand tool functionality is different to the second hand tool functionality.

16. The hand tool system of claim 15, wherein the first hand tool part comprises an electronic hand tool.

17. The hand tool system of claim 16, wherein the first connection part comprises a first electrical connector and the second connection part comprises a second electrical connector;
wherein the first electrical connector and the second electrical connector are configured to form an electrical connection between the first hand tool part and the second hand tool part when the first hand tool part and the second hand tool part are connected together.

18. A hand tool system, comprising:
a first hand tool part;
a second hand tool part configured to be releasably connected together with the first hand tool part to form a combination hand tool;
wherein the first hand tool part has a first hand tool functionality and the second hand tool part has a second hand tool functionality;
wherein the first hand tool part comprises a first electrical connector and the second hand tool part comprises a second electrical connector;
wherein the first electrical connector and the second electrical connector are configured to form an electrical connection between the first hand tool part and the second hand tool part when the first hand tool part and the second hand tool part are connected together.

19. The hand tool system of claim 18, wherein at least one of the first electrical connector and the second electrical connector comprises a resilient connector.

20. The hand tool system of claim 19, wherein the first hand tool part comprises an electronic hand tool and wherein the electronic hand tool is a distance measurer.
